(19) United States
(12) Patent Application Publication
(10) Pub. No.: US 2007/0146314 A1
(43) Pub. Date: Jun. 28, 2007

(54) METHOD AND APPARATUS FOR A USER INTERFACE

(75) Inventor: Conor P. O'Sullivan, CRYSTAL LAKE, IL (US)

Correspondence Address: MOTOROLA INC, 600 NORTH US HIGHWAY 45, ROOM AS437, LIBERTYVILLE, IL, 60048-5343, US

(73) Assignee: MOTOROLA, INC., LIBERTYVILLE, IL (US)

(21) Appl. No.: 11/614,565

(22) Filed: Dec. 21, 2006

Related U.S. Application Data
(60) Provisional application No. 60/754,133, filed on Dec. 27, 2005.

(51) Int. Cl. G09G 5/00

(52) U.S. Cl. 345/156

(57) ABSTRACT

A system and method for mixing a data file in a portable electronic device (100), to modify the output of the data file, are provided. The portable electronic device includes a user interface (102), a filtering module (202), and a processing module (204). The user interface is configured to receive inputs through a physical motion. The filtering module is configured to provide at least one filter effect to the output of the data file. The processing module is configured to interpret the physical motion and to modify the output of the data file. The processing module is operatively linked with the user interface and the filtering module.

### FIELD OF THE INVENTION

The present invention relates generally to the field of electronic devices, and specifically to a disc jockey interface in portable electronic devices.

### BACKGROUND OF THE INVENTION

With the advancement of technology, there are changes in the design and usage of portable electronic devices. Devices such as mobile phones, Personal Digital Assistants (PDAs) and audio players can perform a variety of functions and entertain users. These devices often use various cutting-edge technologies such as inbuilt cameras, video players, disc jockey interfaces for modifying an audio file in multiple audio formats, and so forth.

A disc jockey interface provides a means for modifying and controlling an audio file. The disc jockey interface can include different user interfaces to provide user inputs through physical interactions.

There are various techniques available, which provide a disc jockey interface in a portable electronic device. However, portable electronic devices utilize processor-intensive computations with large user interfaces to modify and control the audio file. There are music interfaces available in portable devices however, they are limited to generally controlling the playback of an audio file.

### BRIEF DESCRIPTION OF THE FIGURES

The present invention is illustrated by way of example, and not limitation, in the accompanying figures, in which like references indicate similar elements, and in which:

FIG. 1 illustrates a portable electronic device, in accordance with various embodiments of the present invention.

FIG. 2 is a block diagram illustrating a portable electronic device for modifying output of a data file, in accordance with an embodiment of the present invention.

FIG. 3 is a block diagram illustrating a user interface that is configured to modify the output of a data file in a portable electronic device, in accordance with an embodiment of the present invention.

FIG. 4 illustrates a flow diagram for mixing a data file stored in a portable electronic device, to modify the output of the data file, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help to improve understanding of embodiments of the present invention.

### DETAILED DESCRIPTION OF THE EMBODIMENTS

Before describing in detail the particular system and method for modifying the output of a data file in a portable electronic device, in accordance with the present invention, it should be observed that the present invention resides primarily in combinations of system elements and method steps related to the system and method for modifying the output of the data file in a portable electronic device. Accordingly, the apparatus components and method steps have been represented where appropriate by conventional symbols in the drawings, showing only the specific details that are pertinent for an understanding the present invention, so as not to obscure the disclosure with details that will be readily apparent to those with ordinary skill in the art, having the benefit of the description herein.

In accordance with an embodiment of the present invention, a portable electronic device is provided. The portable electronic device is capable of modifying the output of a data file. The portable electronic device includes a user interface, a filtering module, and a processing module. The user interface receives inputs through a physical motion. The filtering module provides at least one filter effect to the output of the data file, based on inputs. The processing module is linked with the user interface and the filtering module. The processing module interprets the physical motion, and modifies the output of the data file based on the physical motion.

In accordance with another embodiment of the present invention, a user interface for a portable electronic device is provided. The user interface modifies the output resulting from data file. The user interface includes a graphical interface and a processing module. The graphical interface receives an input through a DJ scratching motion for example. The processing module interprets the input and modifies the output of the data file.

In accordance with yet another embodiment of the present invention, a method for mixing a data file in order to modify the data file output, is provided. The portable electronic device receives a physical motion input from a user through a touch screen of the portable electronic device. A processing module interprets the physical motion input. The processing module generates output in response to interpreting the physical motion input.

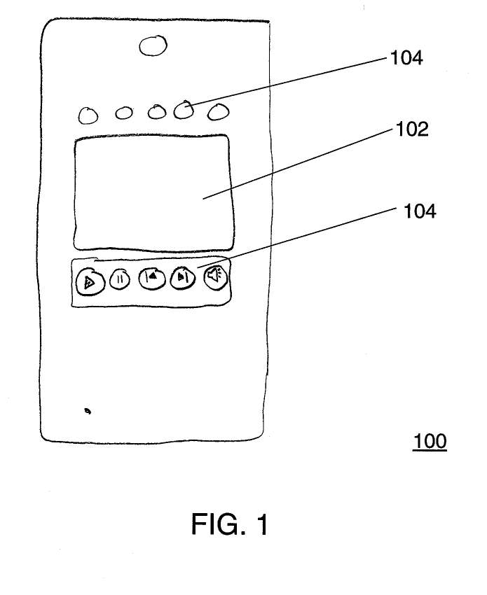

FIG. 1 illustrates a portable electronic device 100, in accordance with various embodiments of the present invention. Examples of the portable electronic device 100 include, but are not limited to, a mobile communication device, an audio player, a gaming device, and a Personal Digital Assistant (PDA). The portable electronic device 100 includes a user interface 102 and a keypad 104. Examples of the user interface 102 include, but are not limited to, a touch screen, a jog-dial, a nudge roller, a keypad and physical sensors. Examples of the physical sensors include, but are not limited to, proximity sensors and accelerometer sensors. The user interface 102 receives inputs through a physical motion. The keypad 104 includes special keys to provide multiple functionalities to the portable electronic device 100.

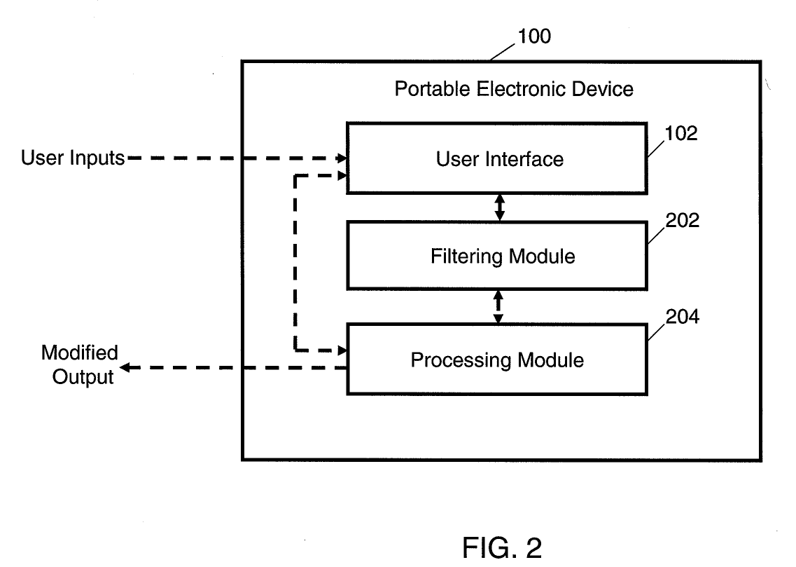

FIG. 2 is a block diagram illustrating the portable electronic device 100 for modifying the output of a data file, in accordance with an embodiment of the present invention. Examples of the data file include, but are not limited to, an audio file and streaming data. The portable electronic device 100 includes the user interface 102, a filtering module 202, and a processing module 204. The user interface 102 receives inputs through a physical motion. In an embodiment of the present invention, the physical motion can be a haptic input. Haptic means pertaining to the sense of touch. A haptic input enables a user to interact with a device using touch, or by using a tool, such as a stylus. These interactions are converted into computations internally in the device. Some other forms of haptic inputs may include high-speed vibrations or other stimuli. In another embodiment of the present invention, the physical motion can be a physical input. The haptic input includes scratching, i.e. a reciprocating motion on the surface, the user interface 102. In one exemplary embodiment of the present invention, the scratching can be done by hand. In another exemplary embodiment of the present invention, scratching can be done by using a stylus. In an embodiment of the present invention, the physical input includes pressing one or more keys of the keypad 104. In another embodiment of the present invention, the physical input includes providing physical gestures, for example, shaking, and vibrating the portable electronic device 100. In yet another embodiment of the present invention, the physical input includes movements in close proximity to the portable electronic device 100.

The filtering module 202 can provide multiple filter effects to modify the output of the data file. Examples of the filter effects include, but are not limited to, a tempo effect, a pitch effect, a cross-fade effect, a reverb-echo effect, a band-pass sweep effect, a low-pass effect, a high-pass effect, a graphic equalizer effect, an amplification effect, a distortion effect and a scratching effect. In an embodiment of the present invention, the filter effects are provided through a haptic input, such as scratching a touch screen. In another embodiment of the present invention, the filter effects are provided through the keypad 104.

The filtering module 202 is operatively coupled to the user interface 102 and the processing module 204. The processing module 204 interprets the physical motion and modifies the output of the data file based on the interpretation of the physical motion. For example, the when the device detects physical input to the user interface, the type of input is determined. A correlation is made to the type of modification that is to be performed on the audio file as a result of the particular motion. The determined modification is then inserted into the audio output in place of the original audio. The original audio from the data file may be paused muted or attenuated while the modified audio is played through the audio output. Once the modified audio is finished playing, the original audio is restarted, unmated or brought back to the original audio level. In this embodiment there is no time gap between the time when the modified audio ends until the time when the original audio resumes.

The portable electronic device 100 may also include a memory module that is configured to store coders and decoders for coding and decoding the data file in multiple audio formats. Examples of the audio formats include, but are not limited to, MIDI, MP3, MP4, XMF, AIFF, WAV, RMI, KAR, MIZ, AAC, APL, OGG, NSA, SND, VOC, and AIJ. The memory module can also store a modified data file generated in response to the modification in the output of the data file.

The portable electronic device 100 may also include a transceiver to transmit the modified data file. In an embodiment of the present invention, the transceiver is operatively linked with the memory module. In another embodiment of the present invention, the transceiver can receive ring tones and the data files and store them in the memory module.

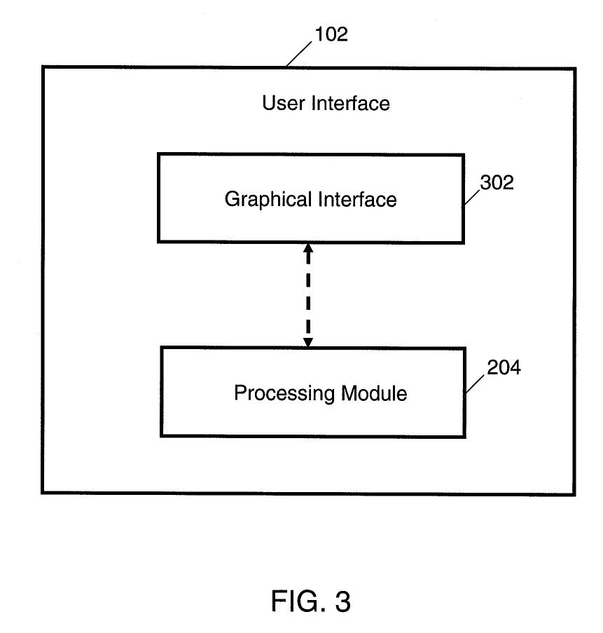

FIG. 3 is a block diagram illustrating the user interface 102, in accordance with an embodiment of the present invention. In an embodiment of the present invention, the user interface 102 includes a graphical interface 302 and the processing module 204. Examples of the graphical interface 302 include, but are not limited to, a touch screen, a plasma screen, a display device and a Liquid Crystal Display (LCD) screen. In an embodiment of the present invention, the graphical interface 302 can receives inputs through scratching. In another embodiment of the present invention, the graphical interface 302 can receive inputs through a physical motion. Examples of physical motion include, but are not limited to, a haptic input and a physical input. The processing module 204 interprets the inputs and hence modifies the output of the data file.

The processing module 204 may be operatively coupled to the filtering module 202, to modify the output of the data file. The processing module 204 may be coupled to the memory module to store the modified data file. The memory module may also be coupled to the transceiver for transmitting the modified data file.

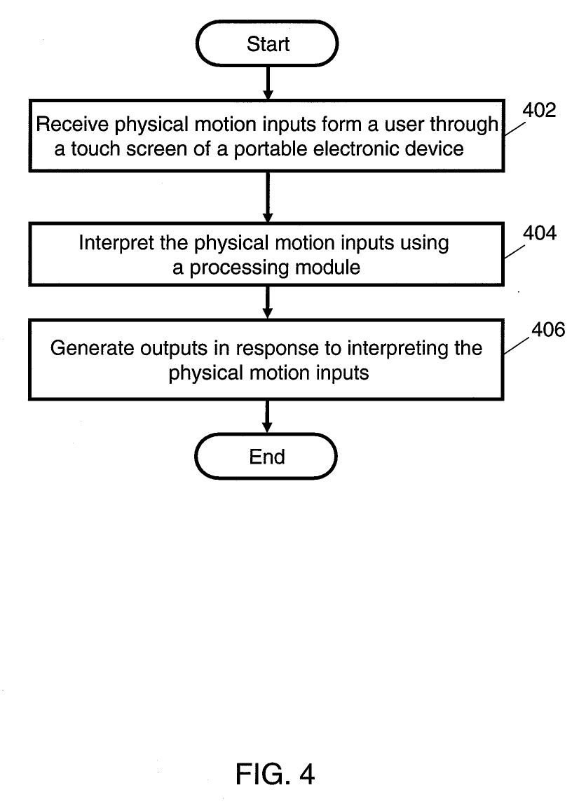

FIG. 4 illustrates a flow diagram illustrating a method for mixing a data file and to modify the output of the data file in the portable electronic device 100, in accordance with an embodiment of the present invention. At step 402, physical motion inputs are received from a user through the touch screen of the portable electronic device 100. At step 404, the physical motion inputs are interpreted by the processing module 204. At step 406, the output is generated in response to the interpretation of the physical motion inputs.

In an embodiment of the present invention, a data file can be mixed by applying filter effects and changing the data file output. The filter effects are generated through the filtering module 202 in the portable electronic device 100. In an embodiment of the present invention, mixing a data file includes mixing data stored at different time intervals in the data file. In another embodiment of the present invention, mixing the data file includes applying multiple filter effects. Examples of mixing include, but are not limited to, mixing the data file, increasing its volume, decreasing its volume, fast-forwarding it, rewinding it, changing it, playing it, pausing it, stopping it, jumping between positions in the track and playing groups of samples in a non-linear fashion.

Various embodiments of the present invention provide multiple functionalities. The portable electronic device 100 can support data files, audio files and streaming data. The portable electronic device 100 can support audio files in multiple audio formats. Therefore users have greater flexibility in transmitting and receiving files in multiple formats among multiple users. Users can modify an incoming ring tone for entertainment before answering a call. The users can also modify an audio file to use it as a ring tone. Further, the user can pause the incoming ring tone, and the paused ring tone can be replayed afterwards.

It will be appreciated the method and electronic device described herein may be comprised of one or more conventional processors and unique stored program instructions that control the one or more processors, to implement, in conjunction with certain non-processor circuits, some, most, or all of the functions of the electronic device described herein. The non-processor circuits may include, but are not limited to, a radio receiver, a radio transmitter, signal drivers, clock circuits, power source circuits, and user input devices. As such, these functions may be interpreted as steps of a method to control the electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

In this document, relational terms such as first and second, and the like, may be used solely to distinguish one entity or action from another, entity or action without necessarily requiring or implying any actual such relationship or order between such entities or actions. The terms “comprises,” “comprising”, “includes”, “including”, or any other variation thereof, are intended to cover a non-exclusive inclusion, such that a process, method, article, or apparatus that comprises a list of elements does not include only those elements, but may include other elements not expressly listed or inherent to such process, method, article, or apparatus. An element preceded by “comprises . . . a” does not, without more constraints, preclude the existence of additional identical elements in the process, method, article, or apparatus that comprises the element. The term “another”, as used herein, is defined as at least a second or more. The terms “including” and/or “having”, as used herein, are defined as comprising.

It is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

In the foregoing specification, the invention and its benefits and advantages have been described with reference to specific embodiments. However, one of ordinary skill in the art appreciates that various modifications and changes can be made, without departing from the scope of the present invention, as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features, or elements of any or all the claims. The invention is defined solely by the appended claims, including any amendments made during the pendency of this application, and all equivalents of those claims, as issued.

What is claimed is:

1. A portable electronic device configured to modify output of a data file, the data file being stored on the portable electronic device, the portable electronic device comprising:
a user interface configured to receive inputs through a physical motion;
a filtering module configured to provide at least one filter effect to the output of the data file based on the physical motion; and
a processing module operatively linked to the user interface and the filtering module, the processing module configured to interpret the physical motion and to modify the output of the data file.

2. The portable electronic device of claim 1, wherein the data file is selected from a group comprising an audio file and streaming data.

3. The portable electronic device of claim 2, wherein the audio file is in an audio format selected from a group comprising MIDI, MP3, MP4, XMF, AIFF, WAV, RMI, KAR, MIZ, AAC, APL, OGG, NSA, SND, VOC and AIJ.

4. The portable electronic device of claim 1, wherein the portable electronic device is selected from a group comprising a mobile communication device, an audio player, a gaming device and a Personal Digital Assistant (PDA).

5. The portable electronic device of claim 1, wherein the user interface is selected from a group comprising a keypad, a touch screen, a jog-dial, a nudge roller and physical sensors.

6. The portable electronic device of claim 5, wherein the physical sensors are selected from a group comprising proximity sensors and accelerometer sensors.

7. The portable electronic device of claim 1, wherein the physical motion comprises a haptic input and a physical input.

8. The portable electronic device of claim 7, wherein the haptic input comprises scratching on the user interface.

9. The portable electronic device of claim 7, wherein the physical input is one or more from physical gestures and movements in close proximity to the portable electronic device.

10. The portable electronic device of claim 1 further comprising a memory module configured to store coder-decoders for coding and decoding the data file.

11. The portable electronic device of claim 1, wherein the memory module further stores a modified data file in response to modifying the output of the data file.

12. The portable electronic device of claim 11 further comprising a transceiver for transmitting the modified data file.

13. The portable electronic device of claim 1, wherein the filtering module provides at least one filter effect from a group comprising a tempo effect, a pitch effect, a cross-fade effect, a reverb-echo effect, a band pass sweep effect, a low pass effect, a high pass effect, a graphic equalizer effect, an amplification effect, a distortion effect and a scratching effect.

14. A user interface for a portable electronic device configured to modify output of a data file, the user interface comprising:
a graphical interface configured to receive a input, the input comprising scratching the graphical interface; and
a processing module configured to interpret the input and to modify the output of the data file.

15. The user interface of claim 14, wherein the data file is selected from a group comprising an audio file and streaming data.

16. The user interface of claim 14, wherein the user interface is selected from a group comprising a keypad, a jog-dial, a nudge roller and physical sensors.

17. The user interface of claim 14, wherein the graphical interface is selected from a group comprising a touch screen and a display device.

18. A method for mixing a data file, the data file being stored on a portable electronic device, the mixing resulting in modification of output of the data file, the method comprising:
receiving a physical motion input from a user through a touch screen of the portable electronic device;
interpreting the physical motion input using a processing module; and
generating output in response to interpreting the physical motion input.

19. The method of claim 18, wherein receiving the physical motion input comprises at least one of providing a haptic input and providing a gesture input.

20. The method of claim 18, wherein receiving the physical motion input comprises at least one of scratching the touch screen and shaking the portable electronic device.

21. The method of claim 18, wherein mixing comprises:
applying at least one filter effect selected from a group comprising a tempo effect, a pitch effect, a cross-fade effect, a reverb-echo effect, a band pass sweep effect, a low pass effect, a high pass effect, a graphic equalizer effect, an amplification effect, a distortion effect and a scratching effect.

22. The method of claim 18, wherein mixing comprises at least one of:
mixing the data file, increasing the volume, decreasing the volume, fast forwarding the data file, rewinding the data file, changing the data file, playing the data file, pausing the data file, stopping the data file, jumping between positions in the track and playing groups of samples in a non-linear fashion.

23. The method of claim 22, wherein mixing the data file comprises mixing data stored at different time intervals in the data file.
